(19) United States
(12) Patent Application Publication
(10) Pub. No.: US 2026/0291866 A1
(43) Pub. Date: Sep. 24, 2026

(54) SEGREGATION AND MAPPING OF LOGICALLY PARTITIONED NETWORK FABRICS

(71) Applicant: Hewlett Packard Enterprise Development LP, Spring, TX (US)

(72) Inventors: Kaliraj Vairavakkalai, Mountain House, CA (US); Natrajan Venkataraman, Los Angeles, CA (US); Reshma Das, Van Nuys, CA (US)

(21) Appl. No.: 19/556,891

(22) Filed: Mar. 4, 2026

Related U.S. Application Data
(60) Provisional application No. 63/774,868, filed on Mar. 20, 2025.

(51) Int. Cl. H04L 45/745

(52) U.S. Cl. CPC H04L 45/745

(57) ABSTRACT

A network device for segregating and mapping logically partitioned network fabrics may include at least one storage device and circuitry. The storage device may be configured to store a first color-specific routing information base (RIB) that includes routes of a first transport class of a communication protocol and a second color-specific RIB that includes routes of a second transport class of the communication protocol. The circuitry may be configured to (1) receive Internet protocol (IP) traffic of the first transport class destined for a node included in a color-specific IP fabric, (2) search the first color-specific RIB for a route entry corresponding to the node included in the color-specific IP fabric, and (3) forward the IP traffic to the node via a route identified by the route entry. Various other devices, systems, and methods are also disclosed.

### CROSS REFERENCE TO RELATED APPLICATION

This application claims the benefit of U.S. Provisional Application No. 63/774,868 filed Mar. 20, 2025, the disclosure of which is incorporated in its entirety by this reference.

### BACKGROUND

Network fabrics may be logically partitioned to satisfy isolation, multi-tenant, and/or service-level requirements. Some forwarding conventions applied in such network fabrics may cause identically prefixed routes from different partitions to collide at overlapping nodes and/or to hide one another in a single forwarding information base (FIB). Unfortunately, these forwarding conventions may undermine deterministic per-partition forwarding across the network fabrics. The instant disclosure identifies and addresses a need for improved segregation and mapping of logically partitioned network fabrics.

### BRIEF DESCRIPTION OF THE DRAWINGS

The accompanying drawings illustrate a number of exemplary embodiments and are a part of the specification. Together with the following description, these drawings demonstrate and explain various principles of the instant disclosure.

FIG. 1 is an illustration of an exemplary network device for segregating and mapping logically partitioned network fabrics according to one or more embodiments of this disclosure.

FIG. 2 is an illustration of an exemplary system for segregating and mapping logically partitioned network fabrics according to one or more embodiments of this disclosure.

FIG. 3 is an illustration of an exemplary logically partitioned IP fabric according to one or more embodiments of this disclosure.

FIG. 4 is an illustration of an exemplary route installed in a partition-specific routing information base (RIB) according to one or more embodiments of this disclosure.

FIG. 5 is an illustration of an exemplary forwarding entry installed in a partition-specific forwarding footprint of a forwarding information base (FIB) according to one or more embodiments of this disclosure.

FIG. 6 is a flow diagram of an exemplary method for segregating and mapping logically partitioned network fabrics in accordance with one or more embodiments of this disclosure.

FIG. 7 is a block diagram of an exemplary computing system capable of implementing and/or being used in connection with one or more of the embodiments described and/or illustrated herein.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

The present disclosure describes various devices, systems, and methods for segregating and mapping logically partitioned network fabrics. As will be explained in greater detail below, embodiments of the present disclosure may facilitate, support, and/or provide Border Gateway Protocol (BGP) Classful Transport (CT) mechanisms for logically segregating and/or mapping multiple colored Internet protocol (IP) fabrics. In some examples, a single node may be configured and/or programmed to support and/or provide IP fabrics of multiple colors (e.g., red, blue, green, yellow, etc.), which are defined and/or implemented via BGP transport classes (e.g., transport-target attributes). In one example, each colored IP fabric may include, constitute, and/or represent a logical and/or virtual partition of a physical IP fabric or network. Any number of colored IP fabrics may be partitioned across a data center Clos IP network.

In some examples, each colored IP fabric may advertise the same prefix, route, and/or address for a certain node. By doing so, the colored IP fabrics may avoid and/or obviate the need to advertise unique IP prefixes, routes, and/or addresses for each node. In one example, each colored IP fabric may correspond to and/or be represented by its own routing information base (RIB) in a given node. For example, a node that supports a red IP fabric and a blue IP fabric may include and/or manage a red RIB and a blue RIB. In this example, the node may also include and/or represent a forwarding information base (FIB) in which footprints mapped to the red and blue RIBs are installed. Accordingly, when colored IP traffic hits the node, the node may forward the colored IP traffic based on the footprint corresponding to the IP traffic’s color installed in the FIB.

In some examples, the FIB may be partitioned to segregate and/or map the colored IP fabrics. Additionally or alternatively, the node may include and/or represent multiple FIBs corresponding to the different colored IP fabrics.

In some examples, a data center Clos IP fabric network may include and/or represent a spine stage and/or a leaf stage that support and/or provide a red IP fabric and a blue IP fabric. In one example, the spine stage may include and/or represent a red spine node, a blue spine node, and/or a red-blue spine node. In this example, the leaf stage may include and/or represent multiple leaf nodes that are each communicatively coupled to the red spine node, the blue spine node, and the red-blue spine node via color-specific links.

In some examples, each leaf node may be able to forward red IP traffic to the red spine node and/or the red-blue spine node. Additionally or alternatively, each leaf node may be able to forward blue IP traffic to the blue spine node and/or the red-blue spine node.

As a specific example, a data center Clos IP fabric network may include and/or represent a red IP fabric and a blue IP fabric. In one example, the data center Clos IP fabric network may include and/or represent a first leaf node assigned a 1.1.1.1 prefix and a second leaf node assigned a 2.2.2.2 prefix. In one example, the data center Clos IP fabric network may include and/or represent a red spine node, a blue spine node, and a red-blue spine node. In this example, the red IP fabric may include and/or represent the red spine node and the red-blue spine node, and the blue IP fabric may include and/or represent the blue spine node and the red-blue spine node.

Continuing with this example, the data center Clos IP fabric network may advertise the 1.1.1.1 and/or 2.2.2.2 prefixes on both the red IP fabric and the blue IP fabric. In this example, the first leaf node may send red IP traffic to the second leaf node via red spine node and/or the red-blue spine node. Additionally or alternatively, the first leaf node may send blue IP traffic to the second leaf node via the blue spine node and/or the red-blue spine node. The red-blue spine node may forward the red and/or blue IP traffic sent from the first leaf node to the second leaf node via corresponding color-specific links.

In some examples, the red-blue spine node may implement a BGP CT mechanism to distinguish between the red and blue FIB entries for the 2.2.2.2 prefix. In one example, a BGP CT (SAFI 76) mechanism may apply and/or assign route distinguishers for the red and blue FIB entries associated with the 2.2.2.2 prefix. By doing so, the BGP CT (SAFI 76) mechanism may enable the red-blue spine node to avoid hiding and/or replacing one of those routes within the FIB. For example, each route installed and/or applied in the FIB may include and/or implement a route target that indicates and/or identifies the color of the IP fabric corresponding to the IP traffic being forwarded.

In one example, the red-blue spine node may receive red IP traffic destined for the second leaf node from the first leaf node. In this example, to facilitate forwarding the red IP traffic to the second leaf node along the red IP fabric, the red-blue spine node may search for the red route corresponding to the second leaf node in the red footprint implemented in the FIB. Additionally or alternatively, to facilitate forwarding the red IP traffic to the second leaf node along the red IP fabric, the red-blue spine node may search for the route corresponding to the second leaf node in the red FIB. The red-blue spine node may then forward the red IP traffic to the second leaf node along the red link between the red-blue spine node and the second leaf node based on the corresponding red route.

In one example, the red-blue spine node may receive blue IP traffic destined for the second leaf node from the first leaf node. In this example, to facilitate forwarding the blue IP traffic to the second leaf node along the blue IP fabric, the red-blue spine node may search for the blue route corresponding to the second leaf node in the blue footprint implemented in the FIB. Additionally or alternatively, to facilitate forwarding the blue IP traffic to the second leaf node along the blue IP fabric, the red-blue spine node may search for the route corresponding to the second leaf node in the blue FIB. The red-blue spine node may then forward the blue IP traffic to the second leaf node along the blue link between the red-blue spine node and the second leaf node based on the corresponding blue route.

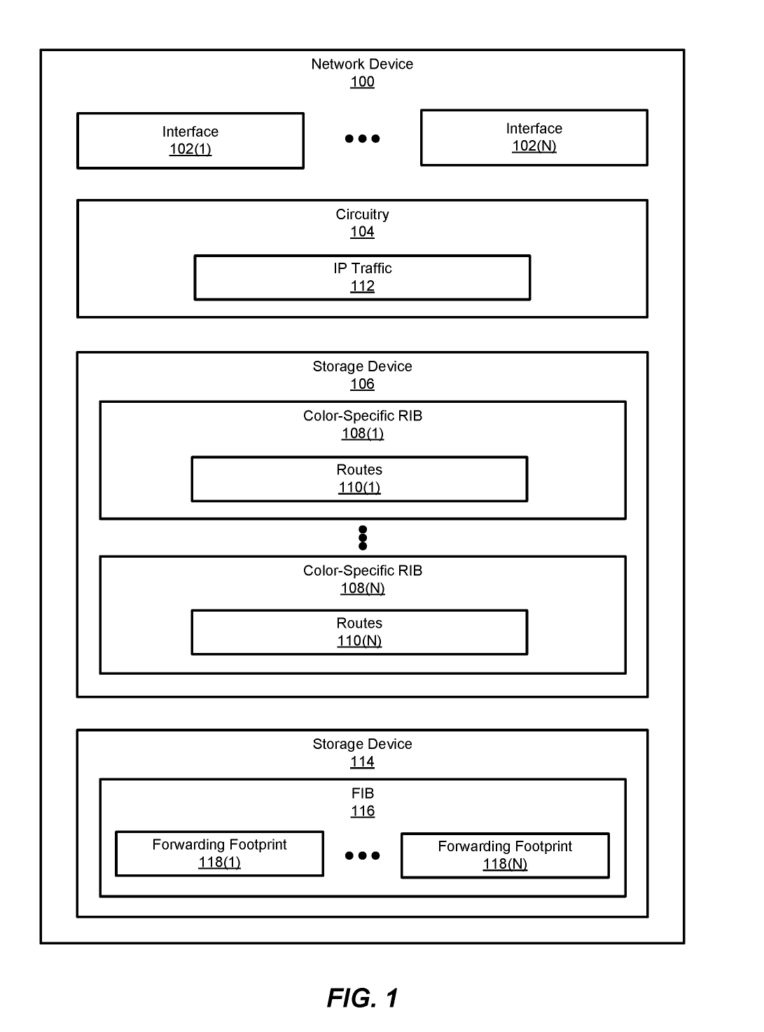

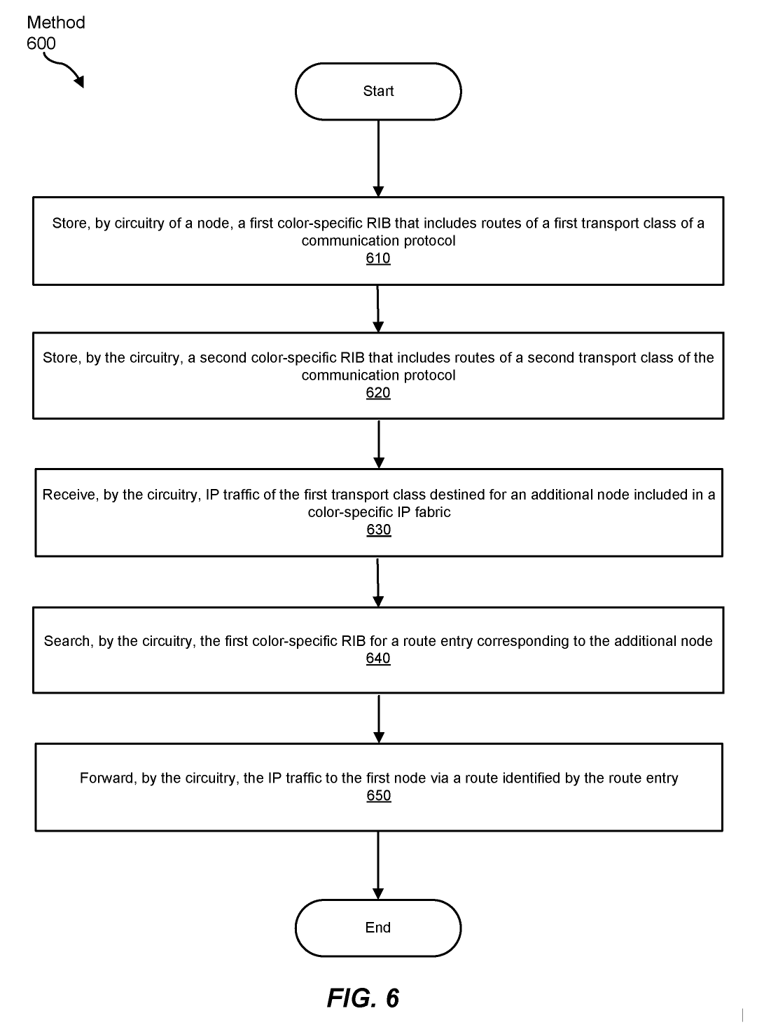

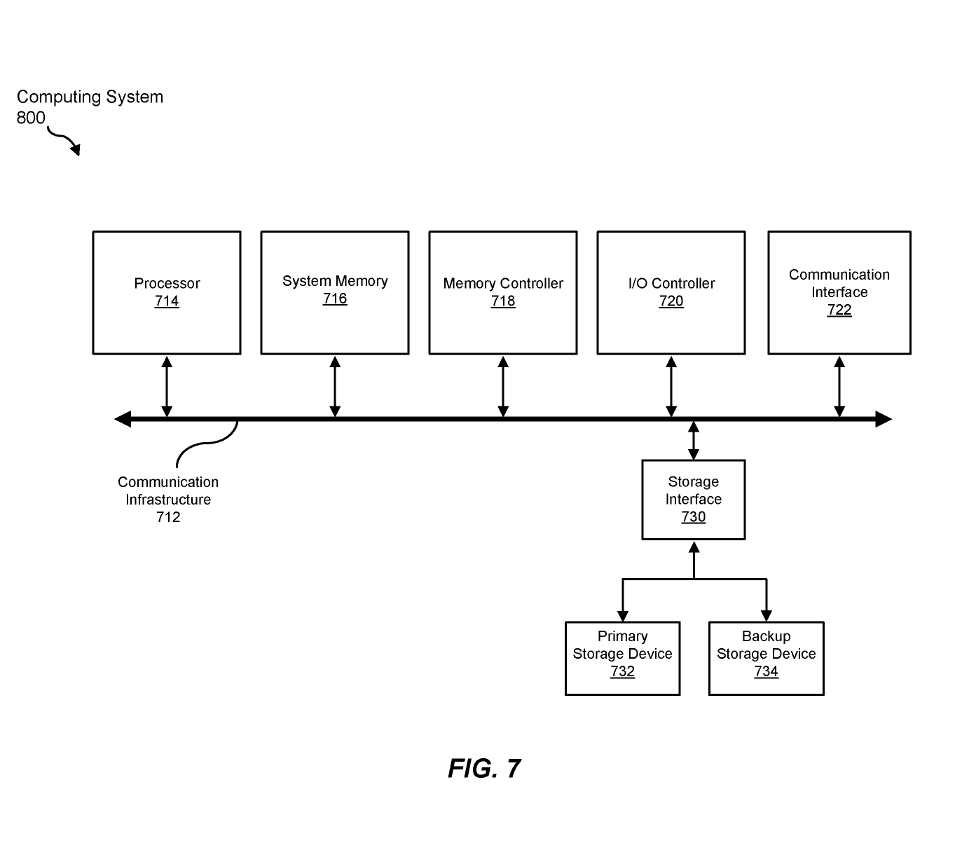

The following will provide, with reference to FIGS. 1-5, detailed descriptions of exemplary devices, systems, and corresponding implementations for segregating and mapping logically partitioned network fabrics. Detailed descriptions of an exemplary method for segregating and mapping logically partitioned network fabrics will be provided in connection with FIG. 6. In addition, detailed descriptions of an exemplary computing system for carrying out these methods will be provided in connection with FIG. 7.

FIG. 1 illustrates an exemplary network device 100 capable of segregating and mapping logically partitioned network fabrics. As illustrated in FIG. 1, exemplary network device 100 may include and/or represent interfaces 102(1)-(N), circuitry 104, storage device 106, and/or storage device 114. In some examples, storage device 106 may store and/or maintain color-specific routing information bases (RIBs) 108(1)-(N) that include routes of different transport classes of a communication protocol. For example, each transport class may correspond to and/or represent a logical and/or virtual partition of an IP fabric. In one example, each transport class may be referred to and/or represented by a certain color (e.g., a red transport class, blue transport class, green transport class, etc.).

Examples of the communication protocol include, without limitation, BGP protocols, , IP version 4 (IPv4), IP version 6 (IPv6), Segment Routing over IPv6 (SRv6), Ethernet Virtual Private Network (EVPN), Layer 3 Virtual Private Network (L3VPN), Virtual Extensible Local Area Network (VXLAN), User Datagram Protocol (UDP), IP-in-IP (IPIP), combinations or variations of one or more of the same, and/or any other suitable communication protocol. As a specific example, the communication protocol may include and/or represent BGP CT (SAFI 76).

In some examples, RIBs 108(1)-(N) may each constitute and/or represent a control-plane data structure that stores comprehensive routing state information learned from one or more routing protocols and/or configurations. In one example, RIBs 108(1)-(N) may store and/or maintain routes 110(1)-(N), respectively. In this example, routes 110(1)-(N) may each include and/or represent a destination prefix, a source protocol, a next hop, metric values, administrative distance, and/or policy tags. In certain implementations, RIBs 108(1)-(N) may be instantiated per transport class. Accordingly, RIBs 108(1)-(N) may correspond to and/or be represented by a certain color (e.g., a red RIB, blue RIB, green RIB, etc.) that denotes the transport class.

In some examples, circuitry 104 may learn identically prefixed routes for different transport classes. In one example, circuitry 104 may store and/or maintain those identically prefixed routes as separate entries in multiple RIBs. In this example, those identically prefixed routes may include and/or represent the same prefix. However, those routes may be distinguished from one another by control-plane identifiers specific to the corresponding transport class. In certain implementations, each transport class may correspond to and/or represent traffic arriving on a different interface.

In some examples, circuitry 104 and/or RIBs 108(1)-(N) may select the best routes and/or paths according to tie-breaker protocols and/or local policies. In one example, circuitry 104 and/or RIBs 108(1)-(N) may produce a set of active routes that are exported to the forwarding plane. In this example, circuitry 104 and/or RIBs 108(1)-(N) may then program those active routes into FIB 116 within a corresponding per-class forwarding context. By doing so, circuitry 104 and/or RIBs 108(1)-(N) may ensure that data-plane lookups in FIB 116 and forwarding decisions reflect the control-plane selections scoped to each transport class.

In some examples, circuitry 104 may bind and/or tie interface 102(1) to the first transport class (e.g., the red transport class) such that all traffic that arrives via interface 102(1) belongs to the first transport class. Additionally or alternatively, circuitry 104 may bind and/or tie interface 102(N) to the second transport class (e.g., the blue transport class) such that all traffic that arrives via interface 102(N) belongs to the second transport class.

In some examples, circuitry 104 may receive IP traffic 112 of a first transport class destined for a node included in a color-specific IP fabric. For example, circuitry 104 may receive IP traffic via interface 102(1). In this example, circuitry 104 may determine that this IP traffic belongs to the red transport class due at least in part to the IP traffic arriving via interface 102(1). The IP traffic may be destined for a node included in the red IP fabric. In one example, circuitry 104 may search RIB 108(1) for a route entry corresponding to the node included in the red IP fabric. Additionally or alternatively, circuitry 104 may forward the IP traffic of the red transport class to the node via a route and/or prefix identified by that route entry.

In some examples, circuitry 104 may receive additional IP traffic of a second transport class destined for that same node as IP traffic 112. In one example, that node may also be included in and/or represent part of an additional color-specific IP fabric. In other words, that node may be shared by and/or represent part of multiple color-specific IP fabrics. For example, circuitry 104 may receive IP traffic via interface 102(N). In this example, circuitry 104 may determine that this IP traffic belongs to the blue transport class due at least in part to the IP traffic arriving via interface 102(N). The IP traffic may be destined for a node included in the blue IP fabric. In one example, circuitry 104 may search RIB 108(N) for a route entry corresponding to the node included in the blue IP fabric. Additionally or alternatively, circuitry 104 may forward the IP traffic of the blue transport class to the node via a route and/or prefix identified by that route entry.

In some examples, circuitry 104 may maintain and/or apply color-specific forwarding footprints 118(1)-(N) mapped to different transport classes within FIB 116. For example, color-specific forwarding footprint 118(1) may be mapped to the red transport class, and/or color-specific forwarding footprint 118(N) may be mapped to the blue transport class. In one example, circuitry 104 may perform a destination lookup for IP traffic 112 of the red transport class within forwarding footprint 118(1) of FIB 116. During this destination lookup, circuitry 104 may identify and/or detect a forwarding entry that corresponds to IP traffic 112 and is scoped to forwarding footprint 118(1). In this example, circuitry 104 may forward IP traffic 112 to the next hop toward its destination based at least in part on that forwarding entry.

In another example, circuitry 104 may perform a destination lookup for IP traffic of the blue transport class within forwarding footprint 118(N) of FIB 116. During this destination lookup, circuitry 104 may identify and/or detect a forwarding entry that corresponds to the IP traffic of the blue transport class and is scoped to forwarding footprint 118(N). In this example, circuitry 104 may forward this IP traffic to the next hop toward its destination based at least in part on that forwarding entry.

In some examples, network device 100 may include and/or implement multiple FIBs that each serve as a forwarding table. In other examples, network device 100 may include and/or represent multiple partitions, footprints, and/or contexts within a single FIB, and each of those partitions, footprints, and/or contexts may serve as a forwarding table. In one example, circuitry 104 may bypass a default forwarding table to perform the destination lookup exclusively within forwarding footprint 118(1) due at least in part to IP traffic 112 having arrived via interface 102(1). Additionally or alternatively, circuitry 104 may bypass the default forwarding table to perform the destination lookup exclusively within forwarding footprint 118(N) due at least in part to the IP traffic having arrived via interface 102(N).

In some examples, circuitry 104 may receive, via the control plane, a first fabric route that specifies a next hop and a first color attribute. For example, the first fabric route may identify and/or represent the next hop for destination prefix 1.1.1.1 and/or a red-class attribute. In one example, circuitry 104 may select the first transport class (e.g., the red transport class) for that first fabric route based at least in part on the red-class attribute. In one example, circuitry 104 may resolve the specified next hop within RIB 108(1) due at least in part to the red-class attribute. Additionally or alternatively, circuitry 104 may install and/or program the first fabric route as one of routes 110(1) maintained in RIB 108(1).

In some examples, circuitry 104 may bind the first fabric route to a forwarding footprint 118(1) mapped to the red transport class and then program FIB 116 accordingly. In one example, circuitry 104 may install, for the first fabric route, a forwarding entry in FIB 116 that is scoped to forwarding footprint 118(1). By scoping that forwarding entry to forwarding footprint 118(1), circuitry 104 may ensure that corresponding data-plane lookups and/or forwarding decisions are limited or constrained to forwarding footprint 118(1).

In some examples, circuitry 104 may receive, via the control plane, a second fabric route that specifies a next hop and a second color attribute. For example, the second fabric route may identify and/or represent the next hop for destination prefix 2.2.2.2 and/or a blue-class attribute. In one example, circuitry 104 may select the second transport class (e.g., the blue transport class) for that second fabric route based at least in part on the blue-class attribute. In one example, circuitry 104 may resolve the specified next hop within RIB 108(N) due at least in part to the blue-class attribute. Additionally or alternatively, circuitry 104 may install and/or program the second fabric route as one of routes 110(N) maintained in RIB 108(N).

In some examples, circuitry 104 may bind the second fabric route to a forwarding footprint 118(N) mapped to the blue transport class and then program FIB 116 accordingly. In one example, circuitry 104 may install, for the second fabric route, a forwarding entry in FIB 116 that is scoped to forwarding footprint 118(N). By scoping that forwarding entry to forwarding footprint 118(N), circuitry 104 may ensure that corresponding data-plane lookups and/or forwarding decisions are limited or constrained to forwarding footprint 118(N).

In some examples, circuitry 104 may determine that IP traffic 112 belongs to a particular transport class based at least in part on whether IP traffic 112 matches a fabric route bound to a color-specific context. For example, when IP traffic matches the first fabric route, circuitry 104 may determine that the IP traffic belongs to the first transport class (e.g., the red transport class) associated with RIB 108(1) and forwarding footprint 118(1). Additionally or alternatively, when IP traffic matches the second fabric route, circuitry 104 may determine that the IP traffic belongs to the second transport class (e.g., the blue transport class) associated with RIB 108(N) and forwarding footprint 118(N).

In some examples, circuitry 104 may perform these transport-class determinations irrespective of any interface via which the IP traffic arrives. For example, even if IP traffic is received via interface 102(1) or interface 102(N), circuitry 104 may classify that IP traffic into the transport class corresponding to the matched fabric route (BGP CT) and its color attribute (transport-target). In one example, after such a classification, circuitry 104 may perform destination lookups in FIB 116 exclusively within the forwarding footprint 118(1) or forwarding footprint 118(N) mapped to the transport class indicated by the matched fabric route. In this example, circuitry 104 may forward the IP traffic based at least in part on a forwarding entry scoped to the corresponding forwarding footprint.

In some examples, circuitry 104 may distribute IP traffic of the first transport class toward one or more distribution stages of the corresponding color-specific IP fabric via weighted equal-cost multipath (ECMP) forwarding constrained to forwarding entries scoped to forwarding footprint 118(1). For example, circuitry 104 may identify a forwarding entry that corresponds to the destination prefix of the IP traffic within forwarding footprint 118(1). In this example, the forwarding entry may specify a next-hop list over corresponding egress interfaces. In this example, circuitry 104 may perform the ECMP selection using only the next-hop list and parameters recorded in the forwarding entry. In certain implementations, circuitry 104 may forward the IP traffic toward the leaf stage of the color-specific IP fabric via one or more spines based at least in part on that ECMP selection.

In some examples, circuitry 104 may derive one or more weights for the ECMP selection from tier-specific link bandwidth profiles of the color-specific IP fabric. For example, circuitry 104 may obtain link bandwidth profiles for egress interfaces associated with backbone nodes, spine nodes, and/or leaf nodes. In one example, circuitry 104 may compute corresponding weights and then apply those weights to the next-hop list of the forwarding entry scoped to forwarding footprint 118(1). By weighting the ECMP selection according to the derived values, circuitry 104 may proportionally distribute IP traffic across the available next hops toward the distribution stages based at least in part on the tier-specific link bandwidth of the color-specific IP fabric.

In some examples, circuitry 104 may distribute IP traffic of the second transport class toward one or more distribution stages of the corresponding color-specific IP fabric via weighted ECMP forwarding constrained to forwarding entries scoped to forwarding footprint 118(N). For example, circuitry 104 may identify a forwarding entry that corresponds to the destination prefix of the IP traffic within forwarding footprint 118(N). In this example, the forwarding entry may specify a next-hop list over corresponding egress interfaces. In this example, circuitry 104 may perform the ECMP selection using only the next-hop list and parameters recorded in the forwarding entry. In certain implementations, circuitry 104 may forward the IP traffic toward the leaf stage of the color-specific IP fabric via one or more spines based at least in part on that ECMP selection. Additionally or alternatively, circuitry 104 may compute weights for the ECMP selection and then apply those weights to the next-hop list of the forwarding entry scoped to forwarding footprint 118(N).

In some examples, circuitry 104 may include and/or represent one or more electrical and/or electronic circuits capable of processing, applying, modifying, transforming, displaying, transmitting, receiving, and/or executing data for network device 100. In one example, circuitry 104 may access and/or analyze data stored in one or more storage devices to facilitate and/or support segregating and mapping logically partitioned network fabrics. Additionally or alternatively, circuitry 104 may launch, perform, and/or execute certain executable files, code snippets, and/or computer-readable instructions to facilitate and/or support segregating and mapping logically partitioned network fabrics.

Although illustrated as a single unit in FIG. 1, circuitry 104 may include and/or represent a collection of multiple processing units and/or electrical or electronic components that work and/or operate in conjunction with one another. In one example, circuitry 104 may include and/or represent one or more application-specific integrated circuits (ASICs). Additionally or alternatively, circuitry 104 may include and/or represent one or more central processing units (CPUs) and/or graphics processing units (GPUs). Additional examples of circuitry 104 include, without limitation, processing devices, microprocessors, microcontrollers, field-programmable gate arrays (FPGAs), systems on chips (SoCs), parallel accelerated processors, tensor cores, integrated circuits, chiplets, optical modules, receivers, transmitters, transceivers, storage devices, memory devices, caches, logical circuitry, analog circuitry, portions of one or more of the same, variations or combinations of one or more of the same, and/or any other suitable circuitry.

Storage device 106 and/or storage device 114 may include and/or represent any type or form of volatile or non-volatile storage device or medium capable of storing data, routes, forwarding footprints, and/or computer-readable instructions. In one example, storage device 106 may include and/or represent system memory, control-plane memory, the CPU’s main memory, and/or a Dynamic Random Access Memory (DRAM). Additionally or alternatively, storage device 114 may include and/or represent data-plane memory, ASIC-based memory, Static Random Access Memory (SRAM), and/or Ternary Content-Addressable Memory (TCAM). Additional examples of storage device 106 and/or storage device 114 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

In some examples, interface 102(1)-(N) may each include and/or represent one or more ports, connections, physical interfaces, Ethernet interfaces, optical modules, and/or transceivers that establish and/or support communications between computing devices, such as network devices and/or servers. Additionally or alternatively, interface 102(1)-(N) may each include and/or represent one or more virtual and/or logic interfaces that establish and/or support communications between such computing devices.

In some examples, network device 100 may include and/or represent any type or form of physical computing device capable of reading computer-executable instructions and/or handling or forwarding network traffic. Examples of network device 100 include, without limitation, switches, routers (such as provider edge routers, hub routers, spoke routers, autonomous system boundary routers, and/or area border routers), rackmount telecommunications devices, hubs, modems, bridges, repeaters, gateways (such as broadband network gateways), multiplexers, network adapters, network interfaces, client devices, laptops, tablets, desktops, servers, variations or combinations of one or more of the same, and/or any other suitable computing devices.

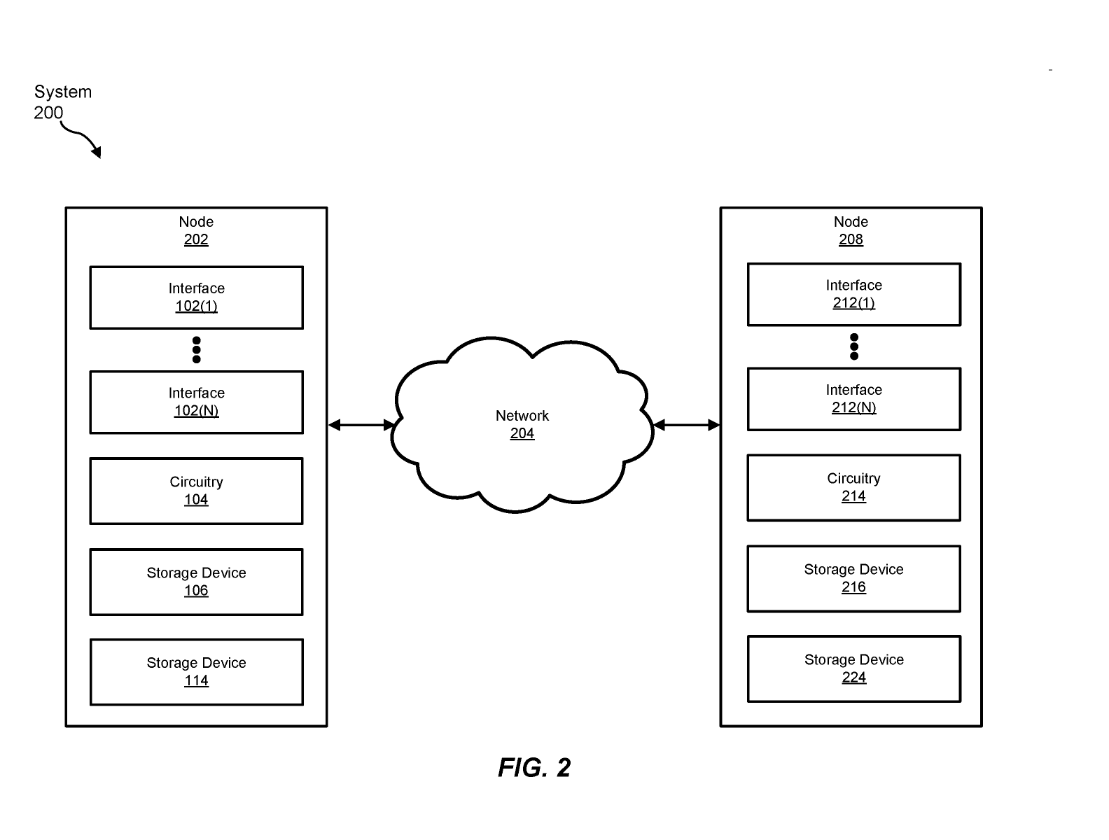

FIG. 2 illustrates an exemplary system 200 that facilitates and/or supports segregating and mapping logically partitioned network fabrics. In some examples, system 200 in FIG. 2 may include and/or involve certain devices, components, configurations, and/or features that perform and/or provide functionalities that are similar and/or identical to those described above in connection with FIG. 1. In one example, system 200 may include and/or represent node 202 and node 208 in communication via a network 204. In this example, node 202 may include and/or represent interfaces 102(1)-(N), circuitry 104, storage device 106, and/or storage device 114. Additionally or alternatively, node 208 may include and/or represent interfaces 212(1)-(N), circuitry 214, storage device 216, and/or storage device 224. In certain implementations, interfaces 212(1)-(N) and/or circuitry 214 may be similar and/or identical to interfaces 102(1)-(N) and/or circuitry 104 included in node 202.

In some examples, circuitry 104 of node 202 may bind one or more of interfaces 102(1)-(N) to respective transport classes and classify IP traffic 112 based at least in part on the corresponding ingress interface and/or service-route matching. Upon classifying IP traffic 112 into a transport class, circuitry 104 may search the corresponding color-specific RIB for a route entry and perform a destination lookup in FIB 116 exclusively within the forwarding footprint mapped to that transport class. Circuitry 104 may then forward IP traffic 112 toward node 208 via network 204 based at least in part on one or more forwarding entries scoped to the selected forwarding footprint.

In some examples, circuitry 214 of node 208 may operate in a similar and/or identical manner. In one example, nodes 202 and 208 may exchange control-plane information over network 204 to advertise and/or learn the corresponding fabric routes, transport-class reachability, color attributes, and/or next hops. In this example, nodes 202 and 208 may program corresponding forwarding entries into their FIBs. By maintaining discrete color-specific RIBs and forwarding footprints at node 202 and/or node 208, system 200 may facilitate and/or support deterministic, concurrent forwarding for identically prefixed routes across multiple transport classes without path hiding. Additionally or alternatively, system 200 may also facilitate and/or support deterministic, concurrent forwarding while enabling interface-based and/or route-based classification.

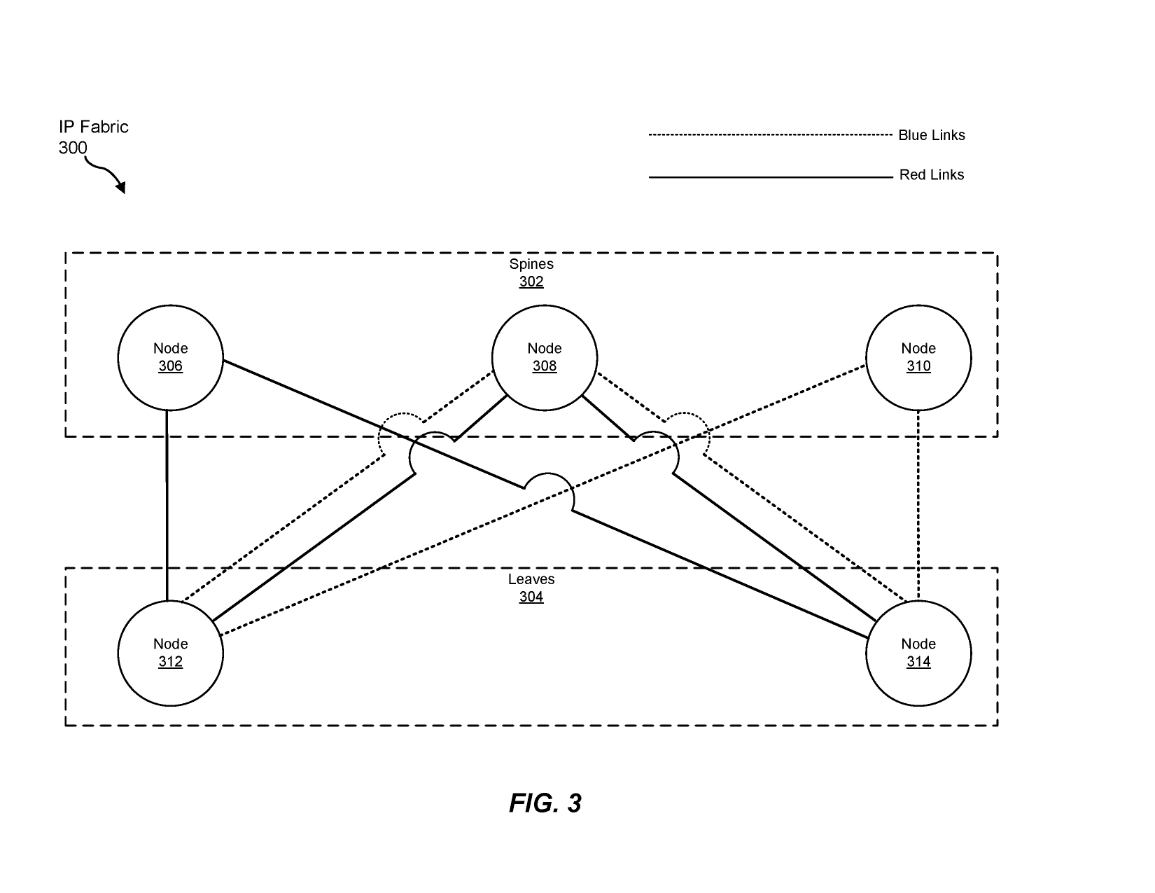

FIG. 3 illustrates an exemplary IP fabric 300 that includes and/or represents different color-specific contexts. In some examples, IP fabric 300 may include and/or represent certain devices, components, configurations, and/or features that perform and/or provide functionalities that are similar and/or identical to those described above in connection with FIGS. 1-3. In one example, IP fabric 300 may include and/or represent spines 302 and leaves 304. In this example, spines 302 may include and/or represent nodes 306, 308, and 310, and leaves 304 may include and/or represent nodes 312 and 314.

In some examples, IP fabric 300 may include and/or represent color-specific partitions and/or contexts. For example, node 306 may be communicatively connected to nodes 312 and 314 via red links (e.g., solid lines), and node 310 may be communicatively connected to nodes 312 and 314 via blue links (e.g., dotted lines). In one example, node 308 may be communicatively connected to nodes 312 and 314 via both red and blue links. In other words, node 308 may be included in and/or shared by both the red partition and the blue partition of IP fabric 300.

In some examples, node 314 may learn, via the control plane, identically prefixed reachability for destination prefix 10.0.0.0/24 from different color-specific partitions of IP fabric 300. For example, node 314 may receive a route encoded as RD1:10.0.0.0/24 that identifies node 310 as a next hop via the blue partition. In this example, node 314 may also receive another route encoded as RD2:10.0.0.0/24 that identifies node 306 as a next hop via the red partition. In one example, node 314 may store those routes as distinct entries in color-specific RIBs 108(1)-(N). In this example, RD1:10.0.0.0/24 may be maintained in RIB 108(N), and RD2:10.0.0.0/24 may be maintained in RIB 108(1). By distinguishing those identically prefixed routes using route distinguishers, node 314 may prevent path hiding and/or overwriting between the color-specific entries in RIBs 108(1)-(N).

In some examples, node 314 may program FIB 116 with color-specific forwarding footprints 118(1)-(N) mapped to corresponding transport classes. For example, forwarding footprint 118(1) may be mapped to the red transport class and include a forwarding entry for RD2:10.0.0.0/24 that forwards IP traffic toward node 306 over a red link. In this example, forwarding footprint 118(N) may be mapped to the blue transport class and include a forwarding entry for RD1:10.0.0.0/24 that forwards IP traffic toward node 310 over a blue link. In one example, those forwarding entries may specify next-hop adjacencies toward spines 302. In certain implementations, those forwarding entries may be constrained to either forwarding footprint 118(1) or forwarding footprint 118(N) depending on the selected transport class.

In some examples, upon receiving IP traffic classified into the red transport class (e.g., via interface binding or service-route matching), node 314 may perform a destination lookup for 10.0.0.0/24 associated with node 312 exclusively within forwarding footprint 118(1) of FIB 116. During this lookup, node 314 may identify the forwarding entry corresponding to RD2:10.0.0.0/24 and then forward the IP traffic toward node 306 over the red link. Additionally or alternatively, upon receiving IP traffic classified into the blue transport class, node 314 may perform a destination lookup for 10.0.0.0/24 associated with node 312 exclusively within forwarding footprint 118(N) of FIB 116. During this lookup, node 314 may identify the forwarding entry corresponding to RD1:10.0.0.0/24 and then forward the IP traffic toward node 310 over the blue link.

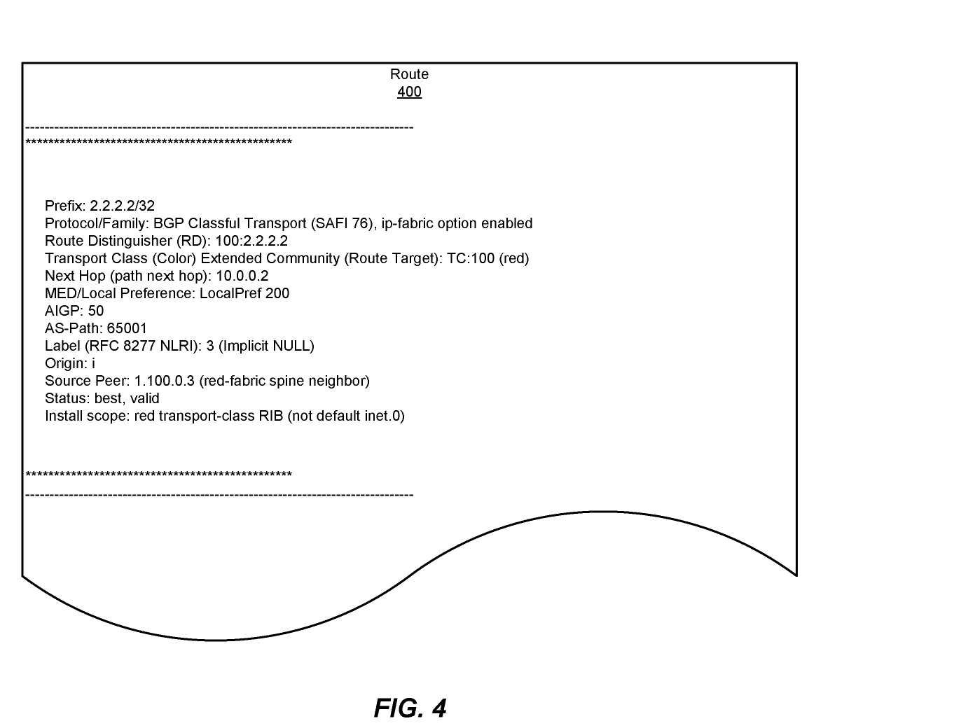

FIG. 4 illustrates an exemplary route 400 stored and/or maintained in a color-specific RIB. In some examples, route 400 in FIG. 4 may include and/or involve certain information, data, and/or features that are similar and/or identical to those described above in connection with any of FIGS. 1-3. In one example, route 400 may include and/or represent destination prefix 2.2.2.2/32 learned via BGP Classful Transport (CT) with an ip-fabric option enabled. In this example, route 400 may be encoded with a route distinguisher RD 100:2.2.2.2 and a transport-class (color) extended community TC:100 that denotes the red transport class. In certain implementations, circuitry 104 may identify a path next hop of 10.0.0.2 for route 400 and record associated attributes, including a local preference of 200, an Accumulated IGP (AIGP) value of 50, and an AS-Path of 65001.

In some examples, route 400 may carry a label value of 3 in RFC 8277 NLRI, which indicates Implicit NULL and causes plain IP forwarding to be installed for the CT route. In one example, route 400 may further indicate an origin code of “i” and a source peer of 1.100.0.3 corresponding to a red-fabric spine neighbor. In this example, based at least in part on a tie-breaker and/or policy evaluation, circuitry 104 may mark route 400 for export to and/or installation in FIB 116. For example, circuitry 104 may install route 400 within RIB 108(1) associated with the red transport class, as opposed to installing route 400 within a default inet.0 routing table. By doing so, circuitry 104 may ensure that forwarding entries derived from route 400 are scoped to forwarding footprint 118(1) in FIB 116 mapped to the red transport class.

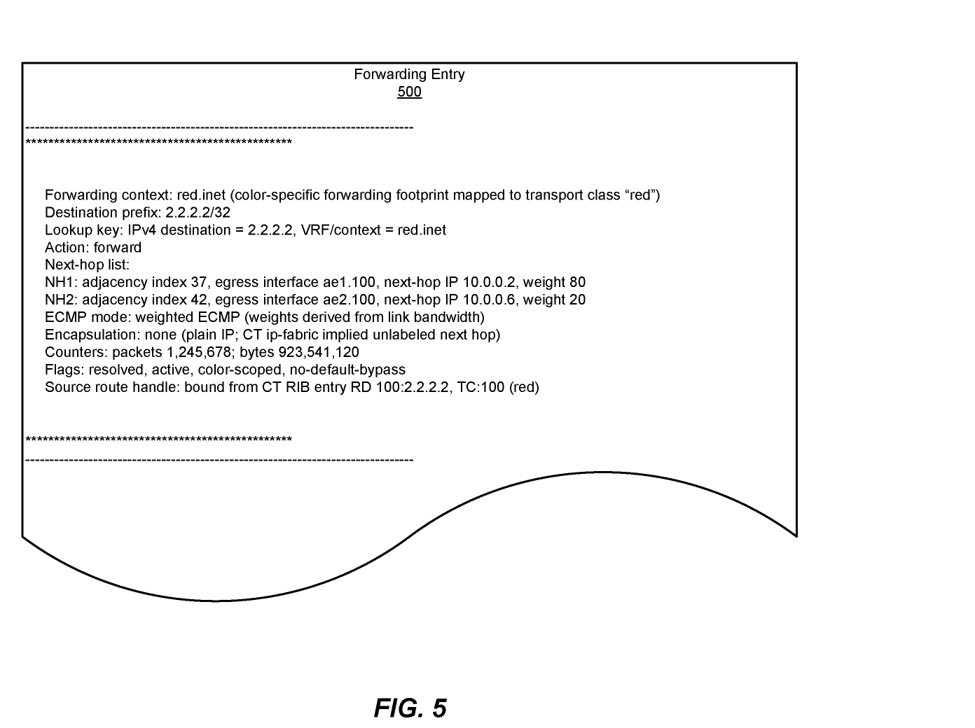

FIG. 5 illustrates an exemplary forwarding entry 500 stored and/or maintained in a color-specific forwarding footprint of a FIB. In some examples, forwarding entry 500 in FIG. 5 may include and/or involve certain information, data, and/or features that are similar and/or identical to those described above in connection with any of FIGS. 1-4. In one example, forwarding entry 500 may include and/or represent a forwarding context red.inet that corresponds to and/or is mapped to forwarding footprint 118(1) associated with the red transport class. In this example, forwarding entry 500 may identify destination prefix 2.2.2.2/32 and/or specify a lookup key that includes an IPv4 destination value of 2.2.2.2 and a context value of red.inet.

In some examples, forwarding entry 500 may indicate an action of forward and/or record an egress next-hop list (e.g., NH1 with adjacency index 37, egress interface ae1.100, next-hop IP address 10.0.0.2, and weight 80; and NH2 with adjacency index 42, egress interface ae2.100, next-hop IP address 10.0.0.6, and weight 20). In one example, forwarding entry 500 may specify weighted ECMP operation with weights derived from link bandwidth. In this example, forwarding entry 500 may indicate no encapsulation, which denotes plain IP forwarding consistent with an ip-fabric option for Classful Transport (unlabeled next hop). Additionally or alternatively, forwarding entry 500 may record counters (e.g., packets 1,245,678 and bytes 923,541,120) and flags (e.g., resolved, active, color-scoped, and no-default-bypass). Forwarding entry 500 may also include a source route handle bound from a Classful Transport RIB entry RD 100:2.2.2.2 with TC:100, which is maintained in RIB 108(1) and programmed into FIB 116.

In some examples, the systems described in connection with FIGS. 1-5 may include and/or represent one or more additional devices, circuits, components, and/or features that are not necessarily illustrated and/or labeled in FIGS. 1-5. For example, the systems illustrated in FIGS. 1-5 may also include and/or represent additional network devices, computing devices, controllers, routers, switches, analog and/or digital circuitry, onboard logic, transistors, transmitters, receivers, transceivers, antennas, resistors, capacitors, diodes, inductors, switches, registers, flipflops, connections, traces, buses, semiconductor (e.g., silicon) devices and/or structures, processing devices, storage devices, circuit boards, sensors, packages, substrates, housings, combinations or variations of one or more of the same, and/or any other suitable components that facilitate and/or support segregating and mapping logically partitioned . In certain implementations, one or more of these additional devices, circuits, components, and/or features may be inserted and/or applied between any of the existing devices, circuits, components, and/or features illustrated in FIGS. 1-5 consistent with the aims and/or objectives described herein. Accordingly, the couplings and/or connections described with reference to FIGS. 1-5 may be direct connections with no intermediate components, devices, and/or nodes or indirect connections with one or more intermediate components, devices, and/or nodes.

In some examples, the phrase “to couple” and/or the term “coupling,” as used herein, may refer to a direct connection and/or an indirect connection. For example, a direct coupling between two components constitutes and/or represents a coupling in which those two devices or components are directly connected to each other by a single node that provides continuity from one of those two devices or components to the other. In other words, the direct coupling excludes and/or omits any additional devices or components between those two devices or components.

Additionally or alternatively, an indirect coupling between two devices and/or components constitutes and/or represents a coupling in which those two devices or components are indirectly connected to each other by multiple nodes that fail to provide direct electrical and/or communicative continuity from one of those two devices or components to the other. In other words, the indirect coupling includes and/or incorporates at least one additional device or component between those two devices or components.

FIG. 6 is a flow diagram of an exemplary method 600 for segregating and mapping logically partitioned network fabrics. In one example, the steps shown in FIG. 6 may be achieved and/or accomplished by a computing device executing a component whose state is being captured. Additionally or alternatively, the steps shown in FIG. 6 may incorporate and/or involve certain sub-steps and/or variations consistent with the descriptions provided above in connection with FIGS. 1-5.

As illustrated in FIG. 6, method 600 may include the step of storing, by circuitry of a node, a first color-specific RIB that includes routes of a first transport class of a communication protocol (610). Step 610 may be performed in a variety of ways, including any of those described above in connection with FIGS. 1-5. For example, circuitry of a network device may store and/or maintain a first color-specific RIB that includes routes of a first transport class of a communication protocol.

Method 600 may also include the step of storing, by circuitry of a node, a second color-specific RIB that includes routes of a second transport class of a communication protocol (620). Step 620 may be performed in a variety of ways, including any of those described above in connection with FIGS. 1-5. For example, the circuitry may store and/or maintain a second color-specific RIB that includes routes of a second transport class of a communication protocol.

Method 600 may further include the step of receiving IP traffic of the first transport class destined for an additional node included in a color-specific IP fabric (630). Step 630 may be performed in a variety of ways, including any of those described above in connection with FIGS. 1-6. For example, the circuitry may receive IP traffic of the first transport class destined for an additional node included in a color-specific IP fabric.

Method 600 may further include the step of searching the first color-specific RIB for a route entry corresponding to the additional node (640). Step 640 may be performed in a variety of ways, including any of those described above in connection with FIGS. 1-6. For example, the circuitry may search the first color-specific RIB for a route entry corresponding to the additional node.

Method 600 may further include the step of forwarding the IP traffic to the first node via a route identified by the route entry (650). Step 650 may be performed in a variety of ways, including any of those described above in connection with FIGS. 1-6. For example, the circuitry may forward the IP traffic to the first node via a route identified by the route entry.

FIG. 7 is a block diagram of an exemplary computing system 700 capable of implementing and/or being used in connection with one or more of the embodiments described and/or illustrated herein. In some embodiments, all or a portion of computing system 700 may perform and/or be a means for performing, either alone or in combination with other elements, one or more of the steps described in connection with FIG. 6. All or a portion of computing system 700 may also perform and/or be a means for performing and/or implementing any other steps, methods, or processes described and/or illustrated herein. In one example, computing system 700 may include and/or store all or a portion of certain software modules.

Computing system 700 broadly represents any type or form of electrical load, including a single or multi-processor computing device or system capable of executing computer-readable instructions. Examples of computing system 700 include, without limitation, workstations, laptops, client-side terminals, servers, distributed computing systems, mobile devices, network switches, network routers (e.g., backbone routers, edge routers, core routers, mobile service routers, broadband routers, etc.), network appliances (e.g., network security appliances, network control appliances, network timing appliances, SSL VPN (Secure Sockets Layer Virtual Private Network) appliances, etc.), network controllers, gateways (e.g., service gateways, mobile packet gateways, multi-access gateways, security gateways, etc.), and/or any other type or form of computing system or device.

Computing system 700 may be programmed, configured, and/or otherwise designed to comply with one or more networking protocols. According to certain embodiments, computing system 700 may be designed to work with protocols of one or more layers of the Open Systems Interconnection (OSI) reference model, such as a physical layer protocol, a link layer protocol, a network layer protocol, a transport layer protocol, a session layer protocol, a presentation layer protocol, and/or an application layer protocol. For example, computing system 700 may include a network device configured according to a Universal Serial Bus (USB) protocol, an Institute of Electrical and Electronics Engineers (IEEE) 1394 protocol, an Ethernet protocol, a T1 protocol, a Synchronous Optical Networking (SONET) protocol, a Synchronous Digital Hierarchy (SDH) protocol, an Integrated Services Digital Network (ISDN) protocol, an Asynchronous Transfer Mode (ATM) protocol, a Point-to-Point Protocol (PPP), a Point-to-Point Protocol over Ethernet (PPPoE), a Point-to-Point Protocol over ATM (PPPoA), a Bluetooth protocol, an IEEE 802.XX protocol, a frame relay protocol, a token ring protocol, a spanning tree protocol, and/or any other suitable protocol.

Computing system 700 may include various network and/or computing components. For example, computing system 700 may include at least one processor 714 and a system memory 716. Processor 714 generally represents any type or form of processing unit capable of processing data or interpreting and executing instructions. For example, processor 714 may represent an application-specific integrated circuit (ASIC), a system on a chip (e.g., a network processor), a hardware accelerator, a general purpose processor, and/or any other suitable processing element.

Processor 714 may process data according to one or more of the networking protocols discussed above. For example, processor 714 may execute or implement a portion of a protocol stack, may process packets, may perform memory operations (e.g., queuing packets for later processing), may execute end-user applications, and/or may perform any other processing tasks.

System memory 716 generally represents any type or form of volatile or non-volatile storage device or medium capable of storing data and/or other computer-readable instructions. Examples of system memory 716 include, without limitation, Random Access Memory (RAM), Read Only Memory (ROM), flash memory, or any other suitable memory device. Although not required, in certain embodiments computing system 700 may include both a volatile memory unit (such as, for example, system memory 716) and a non-volatile storage device (such as, for example, primary storage device 732, as described in detail below). System memory 716 may be implemented as shared memory and/or distributed memory in a network device. Furthermore, system memory 716 may store packets and/or other information used in networking operations.

In certain embodiments, exemplary computing system 700 may also include one or more components or elements in addition to processor 714 and system memory 716. For example, as illustrated in FIG. 7, computing system 700 may include a memory controller 718, an Input/Output (I/O) controller 720, and a communication interface 722, each of which may be interconnected via communication infrastructure 712. Communication infrastructure 712 generally represents any type or form of infrastructure capable of facilitating communication between one or more components of a computing device. Examples of communication infrastructure 712 include, without limitation, a communication bus (such as a Serial ATA (SATA), an Industry Standard Architecture (ISA), a Peripheral Component Interconnect (PCI), a PCI Express (PCIe), and/or any other suitable bus), and a network.

Memory controller 718 generally represents any type or form of device capable of handling memory or data or controlling communication between one or more components of computing system 700. For example, in certain embodiments memory controller 718 may control communication between processor 714, system memory 716, and I/O controller 720 via communication infrastructure 712. In some embodiments, memory controller 718 may include a Direct Memory Access (DMA) unit that may transfer data (e.g., packets) to or from a link adapter.

I/O controller 720 generally represents any type or form of device or module capable of coordinating and/or controlling the input and output functions of a computing device. For example, in certain embodiments I/O controller 720 may control or facilitate transfer of data between one or more elements of computing system 700, such as processor 714, system memory 716, communication interface 722, and storage interface 730.

Communication interface 722 broadly represents any type or form of communication device or adapter capable of facilitating communication between exemplary computing system 700 and one or more additional devices. For example, in certain embodiments communication interface 722 may facilitate communication between computing system 700 and a private or public network including additional computing systems. Examples of communication interface 722 include, without limitation, a link adapter, a wired network interface (such as a network interface card), a wireless network interface (such as a wireless network interface card), and any other suitable interface. In at least one embodiment, communication interface 722 may provide a direct connection to a remote server via a direct link to a network, such as the Internet. Communication interface 722 may also indirectly provide such a connection through, for example, a local area network (such as an Ethernet network), a personal area network, a wide area network, a private network (e.g., a virtual private network), a telephone or cable network, a cellular telephone connection, a satellite data connection, or any other suitable connection.

In certain embodiments, communication interface 722 may also represent a host adapter configured to facilitate communication between computing system 700 and one or more additional network or storage devices via an external bus or communications channel. Examples of host adapters include, without limitation, Small Computer System Interface (SCSI) host adapters, Universal Serial Bus (USB) host adapters, IEEE 1394 host adapters, Advanced Technology Attachment (ATA), Parallel ATA (PATA), Serial ATA (SATA), and External SATA (eSATA) host adapters, Fibre Channel interface adapters, Ethernet adapters, or the like. Communication interface 722 may also enable computing system 700 to engage in distributed or remote computing. For example, communication interface 722 may receive instructions from a remote device or send instructions to a remote device for execution.

As illustrated in FIG. 7, exemplary computing system 700 may also include a primary storage device 732 and/or a backup storage device 734 coupled to communication infrastructure 712 via a storage interface 730. Storage devices 732 and 734 generally represent any type or form of storage device or medium capable of storing data and/or other computer-readable instructions. For example, storage devices 732 and 734 may represent a magnetic disk drive (e.g., a so-called hard drive), a solid state drive, a floppy disk drive, a magnetic tape drive, an optical disk drive, a flash drive, or the like. Storage interface 730 generally represents any type or form of interface or device for transferring data between storage devices 732 and 734 and other components of computing system 700.

In certain embodiments, storage devices 732 and 734 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Storage devices 732 and 734 may also include other similar structures or devices for allowing computer software, data, or other computer-readable instructions to be loaded into computing system 700. For example, storage devices 732 and 734 may be configured to read and write software, data, or other computer-readable information. Storage devices 732 and 734 may be a part of computing system 700 or may be separate devices accessed through other interface systems.

Many other devices or subsystems may be connected to computing system 700. Conversely, all of the components and devices illustrated in FIG. 7 need not be present to practice the embodiments described and/or illustrated herein. The devices and subsystems referenced above may also be interconnected in different ways from those shown in FIG. 7. Computing system 700 may also employ any number of software, firmware, and/or hardware configurations. For example, one or more of the exemplary embodiments disclosed herein may be encoded as a computer program (also referred to as computer software, software applications, computer-readable instructions, or computer control logic) on a computer-readable medium. The term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives and floppy disks), optical-storage media (e.g., Compact Disks (CDs) and Digital Video Disks (DVDs)), electronic-storage media (e.g., solid-state drives and flash media), and other distribution systems.

While the foregoing disclosure sets forth various embodiments using specific block diagrams, flowcharts, and examples, each block diagram component, flowchart step, operation, and/or component described and/or illustrated herein may be implemented, individually and/or collectively, using a wide range of hardware, software, or firmware (or any combination thereof) configurations. In addition, any disclosure of components contained within other components should be considered exemplary in nature since many other architectures can be implemented to achieve the same functionality.

In some examples, all or a portion of network device 100 in FIG. 1 may represent portions of a cloud-computing or network-based environment. Cloud-computing and network-based environments may provide various services and applications via the Internet. These cloud-computing and network-based services (e.g., software as a service, platform as a service, infrastructure as a service, etc.) may be accessible through a web browser or other remote interface. Various functions described herein may also provide network switching capabilities, gateway access capabilities, network security functions, content caching and delivery services for a network, network control services, and/or and other networking functionality.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A network device comprising:
at least one storage device configured to store:
a first color-specific routing information base (RIB) that includes routes of a first transport class of a communication protocol; and
a second color-specific RIB that includes routes of a second transport class of the communication protocol; and
circuitry communicatively coupled to the storage device, the circuitry configured to:
receive Internet protocol (IP) traffic of the first transport class destined for a node included in a color-specific IP fabric;
search the first color-specific RIB for a route entry corresponding to the node included in the color-specific IP fabric; and
forward the IP traffic to the node via a route identified by the route entry.

2. The network device of claim 1, wherein:
the node is also included in an additional color-specific IP fabric; and
the circuitry is further configured to:
receive IP traffic of the second transport class destined for the node as included in the additional color-specific IP fabric;
search the second color-specific RIB for an additional route entry corresponding to the node included in the additional color-specific IP fabric; and
forward the IP traffic of the second transport class to the node via the route as identified by the additional route entry.

3. The network device of claim 2, wherein the circuitry is further configured to:
bind a first interface to the first transport class and a second interface to the second transport class;
determine that the IP traffic of the first transport class belongs to the first transport class due at least in part to the IP traffic of the first transport class having arrived via the first interface; and
determine that the IP traffic of the second transport class belongs to the second transport class due at least in part to the IP traffic of the second transport class having arrived via the second interface.

4. The network device of claim 3, wherein the circuitry is further configured to:
maintain, in a forwarding information base (FIB), a first color-specific forwarding footprint mapped to the first transport class;
maintain, in the FIB, a second color-specific forwarding footprint mapped to the second transport class;
perform, within the first color-specific forwarding footprint, a destination lookup for the IP traffic of the first transport class;
identify, during the destination lookup, one or more forwarding entries scoped to the first color-specific forwarding footprint; and
forward the IP traffic of the first transport class based at least in part on the one or more forwarding entries.

5. The network device of claim 4, wherein the circuitry is further configured to bypass a default forwarding table to perform the destination lookup exclusively within the first color-specific forwarding footprint due at least in part to the IP traffic of the first transport class having arrived via the first interface.

6. The network device of claim 1, wherein the circuitry is further configured to:
receive, via a control plane, a first fabric route that specifies a next hop and a first color attribute;
select, based at least in part on the first color attribute, the first transport class for the first fabric route;
resolve the next hop within the first color-specific RIB;
bind the first fabric route to a first color-specific forwarding footprint mapped to the first transport class; and
install, for the first fabric route in a forwarding information base (FIB), one or more forwarding entries scoped to the first color-specific forwarding footprint of the first transport class.

7. The network device of claim 6, wherein the circuitry is further configured to:
receive, via the control plane, a second fabric route that specifies a different next hop and a second color attribute;
select, based at least in part on the second color attribute, the second transport class for the second fabric route;
resolve the different next hop within the second color-specific RIB;
bind the second fabric route to a second color-specific forwarding footprint mapped to the second transport class; and
install, for the second fabric route in the FIB, one or more additional forwarding entries scoped to the second color-specific forwarding footprint of the second transport class.

8. The network device of claim 6, wherein the circuitry is further configured to:
determine that the IP traffic of the first transport class belongs to the first transport class due at least in part to the IP traffic of the first transport class matching the first fabric route; and
determine that the IP traffic of the second transport class belongs to the second transport class due at least in part to the IP traffic of the second transport class matching the second fabric route.

9. The network device of claim 8, wherein the circuitry is further configured to determine that the IP traffic of the first transport class belongs to the first transport class and the IP traffic of the second transport class belongs to the second transport class irrespective of any interface via which the IP traffic of the first transport class or the second transport class arrives.

10. The network device of claim 6, wherein the circuitry is further configured to forward the IP traffic of the first transport class based at least in part on the one or more forwarding entries.

11. The network device of claim 6, wherein the circuitry is further configured to distribute the IP traffic of the first transport class toward one or more distribution stages via weighted equal-cost multipath (ECMP) forwarding constrained to the one or more forwarding entries.

12. The network device of claim 11, wherein the circuitry is further configured to:
derive one or more weights from one or more tier-specific link bandwidth profiles of the color-specific IP fabric; and
weight the ECMP forwarding by the one or more derived weights.

13. A system comprising:
a first node included in a color-specific Internet protocol (IP) fabric; and
a second node communicatively coupled to the first node, wherein the second node is configured to:
store a first color-specific routing information base (RIB) that includes routes of a first transport class of a communication protocol;
store a second color-specific RIB that includes routes of a second transport class of the communication protocol;
receive IP traffic of the first transport class destined for the first node included in the color-specific IP fabric;
search the first color-specific RIB for a route entry corresponding to the first node; and
forward the IP traffic to the first node via a route identified by the route entry.

14. The system of claim 13, wherein:
The first node is also included in an additional color-specific IP fabric; and
the second node is further configured to:
receive IP traffic of the second transport class destined for the first node as included in the additional color-specific IP fabric;
search the second color-specific RIB for an additional route entry corresponding to the node included in the additional color-specific IP fabric; and
forward the IP traffic of the second transport class to the node via the route as identified by the additional route entry.

15. The system of claim 14, wherein the second node is further configured to:
bind a first interface to the first transport class and a second interface to the second transport class;
determine that the IP traffic of the first transport class belongs to the first transport class due at least in part to the IP traffic of the first transport class having arrived via the first interface; and
determine that the IP traffic of the second transport class belongs to the second transport class due at least in part to the IP traffic of the second transport class having arrived via the second interface.

16. The system of claim 15, wherein the second node is further configured to:
maintain, in a forwarding information base (FIB), a first color-specific forwarding footprint mapped to the first transport class;
maintain, in the FIB, a second color-specific forwarding footprint mapped to the second transport class;
perform, within the first color-specific forwarding footprint, a destination lookup for the IP traffic of the first transport class;
identify, during the destination lookup, one or more forwarding entries scoped to the first color-specific forwarding footprint; and
forward the IP traffic of the first transport class based at least in part on the one or more forwarding entries.

17. The system of claim 16, wherein the second node is further configured to bypass a default forwarding table to perform the destination lookup exclusively within the first color-specific forwarding footprint due at least in part to the IP traffic of the first transport class having arrived via the first interface.

18. The system of claim 13, wherein the second node is further configured to:
receive, via a control plane, a first fabric route that specifies a next hop and a first color attribute;
select, based at least in part on the first color attribute, the first transport class for the first fabric route;
resolve the next hop within the first color-specific RIB;
bind the first fabric route to a first color-specific forwarding footprint mapped to the first transport class; and
install, for the first fabric route in a forwarding information base (FIB), one or more forwarding entries scoped to the first color-specific forwarding footprint of the first transport class.

19. The system of claim 18, wherein the second node is further configured to:
receive, via the control plane, a second fabric route that specifies a different next hop and a second color attribute;
select, based at least in part on the second color attribute, the second transport class for the second fabric route;
resolve the different next hop within the second color-specific RIB;
bind the second fabric route to a second color-specific forwarding footprint mapped to the second transport class; and
install, for the second fabric route in the FIB, one or more additional forwarding entries scoped to the second color-specific forwarding footprint of the second transport class.

20. A method comprising:
storing, by circuitry of a node, a first color-specific routing information base (RIB) that includes routes of a first transport class of a communication protocol;
storing, by the circuitry, a second color-specific RIB that includes routes of a second transport class of the communication protocol;
receiving, by the circuitry, Internet protocol (IP) traffic of the first transport class destined for an additional node included in a color-specific IP fabric;
searching, by the circuitry, the first color-specific RIB for a route entry corresponding to the additional node; and
forwarding, by the circuitry, the IP traffic to the first node via a route identified by the route entry.
